(19) United States
(12) Patent Application Publication
(10) Pub. No.: US 2013/0189397 A1
(43) Pub. Date: Jul. 25, 2013

(54) Pet Food Product with Interlocking Feature

(71) Applicant: Pipat Lertviwatkul, Bangkok (TH)

(72) Inventor: Pipat Lertviwatkul, Bangkok (TH)

(73) Assignee: S.I.P. SIAM INTER PACIFIC CO., LTD., Bangkok (TH)

(21) Appl. No.: 13/424,177

(22) Filed: Mar. 19, 2012

Related U.S. Application Data
(63) Continuation of application No. PCT/IB2012/050266, filed on Jan. 19, 2012.

(51) Int. Cl. A23K 1/10; A23K 1/165; A23P 1/08

(52) U.S. Cl. 426/63; 426/89; 426/92; 426/281

(57) ABSTRACT

A pet food product with multiple layers and at least one of the layers includes protrusions that extend into another layer. The protrusions provide a mechanical interlock between layers providing increased resistance to delamination while the pet food product is being masticated. One of the layers may primarily provide palatability while another layer may provide therapy such as dental cleaning. The ability to resist delamination during mastication may result in prolonged delivery of the therapy as the pet chews on the pet food product to experience the palatability of the palatable layer.

### CROSS REFERENCE TO RELATED APPLICATIONS

This application is a continuation of International Application No. PCT/IB2012/050266, with an international filing date of Jan. 19, 2012, entitled “Pet Food Product with Interlocking Feature,” the entire contents of which are each incorporated herein by reference.

### FIELD OF THE INVENTION

The present invention relates generally to pet food products, and in particular to pet treats with a plurality of portions that interlock with each other.

### BACKGROUND OF THE INVENTION

Pet treats are food products generally intended to provide a supplement to a pet's normal diet. Pet treats may be given to a pet for a variety of reasons. For example, pet treats may be given as a reward or incentive related to particular behaviors. Pet treats may also be used for therapeutic reasons, such as to deliver certain nutrients or supplements or to clean teeth. However, to achieve these desired outcomes, the pet treat should be appealing to the pet. Such appeal may be achieved through taste and/or texture.

### SUMMARY OF THE INVENTION

Embodiments of the present invention are directed toward pet food products and related methods of making the pet food products. The pet food products may be used as pet treats. The pet food products may have multiple layers or sections and at least one of the layers or sections may have protrusions that extend into another layer or section. In this regard, the pet food products may include mechanically interlocking layers. Such mechanically interlocking layers may help to prevent separation of the multiple layers or sections both prior to and during mastication by a pet. Where the pet food product is made of two layers with a first layer providing therapy and a second layer providing palatability, the ability to resist delamination during mastication may result in prolonged delivery of the therapy as the pet chews on the pet food product to experience the palatability of the second layer. The therapy, for example, may be in the form of dental cleaning that may occur as a result of the pet masticating on a hard (relative to the second layer) first layer.

A first aspect includes a pet food product. The pet food product includes a first layer and a second layer. The first layer includes a first layer first surface and a first layer second surface. The first layer first surface and the first layer second surface are approximately parallel to each other and a first layer separation distance between the first layer first surface and the first layer second surface defines a thickness of the first layer. The first layer includes a plurality of first layer holes in the first layer first surface, each of which extends at least half way through the thickness of the first layer. The first layer also includes a plurality of first layer protrusions extending from the first layer first surface, each of which extends from the first layer first surface a first layer protrusion distance that is at least equal to half the thickness of the first layer.

The second layer includes a second layer first surface and a second layer second surface. The second layer first surface and the second layer second surface are approximately parallel to each other, and a second layer separation distance between the second layer first surface and the second layer second surface defines a thickness of the second layer. The second layer includes a plurality of second layer holes in the second layer first surface, each of which extends at least half way through the thickness of the second layer. The second layer also includes a plurality of second layer protrusions extending from the second layer first surface, each of which extends from the second layer first surface a second layer protrusion distance that is at least equal to half the thickness of the second layer.

The plurality of first layer protrusions are disposed within the plurality of second layer holes, and the plurality of second layer protrusions are disposed within the plurality of first layer holes. In this regard, the first layer first surface is in contact with the second layer first surface. The pet food product further comprises a length and a width, and the first layer second surface and the second layer second surface are external surfaces of the pet food product.

A number of feature refinements and additional features are applicable to the first aspect. These feature refinements and additional features may be used individually or in any combination. As such, each of the following features that will be discussed may be, but are not required to be, used with any other feature or combination of features of the first aspect.

For example, in an embodiment of the pet food product, the first layer may be harder than the second layer. The first layer may be a hard chewy layer and the second layer may be a soft meaty layer.

The plurality of first layer holes and/or the plurality of second layer holes may be through holes. The plurality of first layer protrusions may extend from the first layer first surface to the second layer second surface, and the plurality of second layer protrusions may extend from the second layer first surface to the first layer second surface. The plurality of first layer protrusions may extend from the first layer first surface to beyond the second layer second surface, and the plurality of second layer protrusions may extend from the second layer first surface to beyond the first layer second surface.

In an embodiment, the length may be at least as large as the width, and the total thickness may be at least 20% of the width. The thickness of the first layer may be equal to the thickness of the second layer. The first and second layers may be of substantially the same size and shape. For example, the length may be between 50 and 200 mm, the width may be between 20 and 80 mm, and the total thickness may be between 6 and 24 mm. The pet food product may have a central longitudinal axis disposed along the length of the pet food product, such that the plurality of first layer holes may be disposed on an opposite side of the central longitudinal axis from the plurality of second layer holes.

In an embodiment, the first layer may have a hardness of at least 50 Shore D, and the second layer has a hardness of at most 45 Shore D. Additionally, the first layer may have a moisture content of between 9 and 10 percent, and the second layer may have a moisture content of between 8 and 11 percent. Further still, the first layer may have a water activity of between 0.451 and 0.456, and the second layer may have a water activity of between 0.410 and 0.420. In one embodiment, the first layer may comprise a starch component, glycerin, pineapple fiber, gelatin, modified starch, natural chicken liver flavor, palm oil, calcium carbonate, titanium dioxide, fructooligosaccharide, sodium propionate, sugar, bromeliad enzyme, and alpha tocopheryl acetate. The starch component may be at least one of wheat gluten or mung bean starch. Additionally, the second layer may comprise a meat component, modified starch, glutinous rice flour, glycerin, gelatin, palm oil, and food color. The meat component may comprise at least one of dried chicken or dried beef.

The first layer and/or second layer may be generally planar. Alternatively, the first layer and/or second layer may be arched

A second aspect includes a pet food product. The pet food product may include a first layer and a second layer. The first layer includes a first layer first surface and a first layer second surface that are approximately parallel to each other. A first layer separation distance between the first layer first surface and the first layer second surface defines a thickness of the first layer. The first layer includes a plurality of holes in the first layer first surface, each of which extends at least half way through the thickness of the first layer

The second layer includes a second layer first surface and a second layer second surface that are approximately parallel to each other. A second layer separation distance between the second layer first surface and the second layer second surface defines a thickness of the second layer. The second layer includes a plurality of protrusions extending from the second layer first surface, each of which extends from the second layer first surface a second layer protrusion distance that is at least equal to half the thickness of the second layer. The plurality of protrusions are disposed within the plurality of holes and the first layer first surface is in contact with the second layer first surface. In this regard, the first layer second surface and the second layer second surface are external surfaces of the pet food product.

A number of feature refinements and additional features are applicable to the second aspect. These feature refinements and additional features may be used individually or in any combination. As such, each of the following features that will be discussed may be, but are not required to be, used with any other feature or combination of features of the second aspect.

For example, in an embodiment of the pet food product, the plurality of holes may be through holes. The plurality of protrusions may extend from the second layer first surface to the first layer second surface, and/or the plurality of protrusions may extend from the second layer first surface to beyond the first layer second surface.

In an embodiment, the first layer and/or the second layer may be generally planar. Alternatively, the first layer and/or the second layer may be arched

A third aspect includes a method of making a pet food product. The method includes forming a first layer made of a first formulation in a first mold. The method further includes removing the first layer from the first mold and inserting the first layer into a second mold. The method further includes injection molding a second layer onto the first layer in the second mold. The injection molding includes injecting a second formulation into the second mold, pushing the second formulation into holes located in the first layer, and surrounding protrusions of the first layer with the second formulation. The method further includes removing the pet food product from the second mold.

A number of feature refinements and additional features are applicable to the third aspect. These feature refinements and additional features may be used individually or in any combination. As such, each of the following features that will be discussed may be, but are not required to be, used with any other feature or combination of features of the third aspect.

For example, in one embodiment of the method the forming step may include injection molding. In this regard, the forming step may include heating the first formulation. Additionally, the forming step may include chilling the first formulation while the first formulation is in the first mold.

Furthermore, the injection molding the second layer step may include heating the second formulation. Also, the injection molding the second layer step may include chilling the second formulation while the second formulation is in the second mold.

In another embodiment, the method may include applying a moisture barrier to the first layer after the forming step and prior to the injection molding the second layer step. For example, chitin or chitosan may be used as the moisture barrier.

Additional aspects and advantages of the present invention will become apparent to one skilled in the art upon consideration of the further description that follows. It should be understood that the detailed description and specific examples are intended for purposes of illustration only and are not intended to limit the scope of the invention. Furthermore, any of the above arrangements, features and/or embodiments may be combined with any of the above aspects where appropriate.

### BRIEF DESCRIPTION OF THE DRAWINGS

For a more complete understanding of the present invention and further advantages thereof, the following Detailed Description of the Invention is provided along with the following drawings.

FIG. 1 is an isometric illustration of a pet treat.

FIG. 2 is an exploded illustration of the pet treat of FIG. 1.

FIG. 3 is an isometric illustration of another embodiment of a pet treat.

FIG. 4 is an illustration of a variation of the embodiment of the pet treat of FIGS. 1 and 2.

### DETAILED DESCRIPTION OF THE INVENTION

In the following description, embodiments of the present invention are set forth in the context of a pet food product in the form of a pet treat that includes two layers that are interlocked with each other. In particular, one layer may include protrusions and another layer may include corresponding holes to receive the protrusions, and together the protrusions and holes may serve to mechanically interlock the layers to each other. Moreover, each layer may include protrusions and holes that correspond to protrusions and holes in the other layer that serve to mechanically interlock the layers to each other. The pet treat may be configured such that each layer has exposed surfaces such that a pet eating the treat may simultaneously feel and/or taste each layer of the treat. The mechanical interlock of the layers may help to preserve the integrity of the treat (e.g., keep the layers interlocked to each other) as it is being eaten such that each of the layers are felt and/or tasted by the pet for an extended duration. This in turn may hold the pet's interest for an extended duration, providing an extended period of enjoyment for the pet. Moreover at least one of the layers may be therapeutic, such as providing a teeth cleaning function while the pet eats the treat. In such a treat, providing an extended period of enjoyment for the pet may also provide an extended duration of therapy.

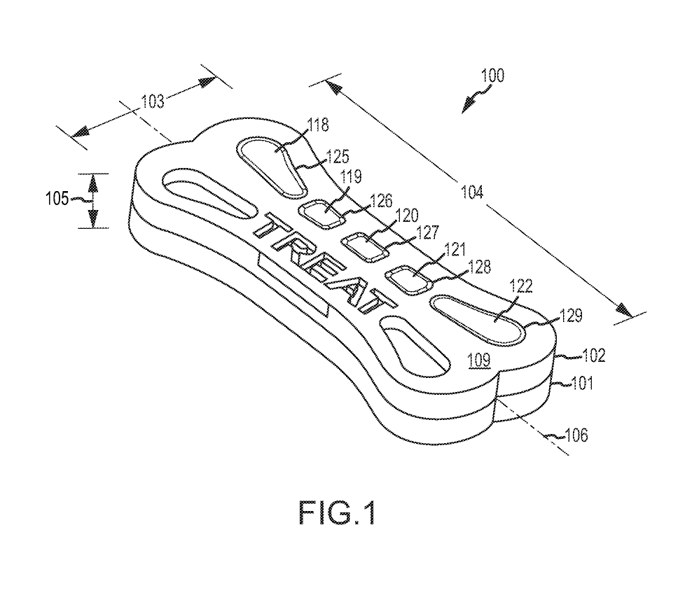

FIG. 1 illustrates a pet food product in the form of a pet treat 100. The pet treat 100 includes a first layer 101 and a second layer 102 that are in contact with each other. Each layer 101, 102 may be substantially planar. Each layer 101, 102 may be in face-to-face contact with the other layer to form the single pet treat 100. The pet treat 100 may have a width 103, a length 104, and a thickness 105. The pet treat 100 may also have a central longitudinal axis 106 disposed along the length 104 of the pet treat 100. Each layer 101, 102 may be about half as thick as the thickness 105, and the total thickness 105 of the pet treat 100 may be equal to the sum of the thicknesses of each layer 101, 102.

The pet treat 100 is shown as being in the shape of a bone. The pet treat 100 may also be formed in other appropriate shapes, such as for example, a pork chop, a T-bone, a rib, or a turkey drumstick. Moreover, the pet treat 100 may be non-planar. For example, the pet treat 100 may be curved such as a rack of ribs may be curved. The pet treat 100 may be appropriately sized for dogs. For example, in a particular embodiment, the length 104 of the pet treat 100 may be about 91 mm, the width 103 may be about 37 mm and the thickness 105 may be about 12 mm. Other embodiments of the pet treat 100 may be sized differently. For example, a larger pet treat 100 may be produced for larger dogs and a smaller pet treat 100 may be produced for small dogs or cats. Accordingly, embodiments of the pet treat 100 may have an overall length of between 50 and 200 mm, a width of between 20 and 80 mm, and a total thickness (the combined thickness of the first layer 101 and the second layer 102) of between 6 and 24 mm. Larger and smaller pet treats 100 are also contemplated.

The thickness 105 may be selected to provide a particular sensation when being eaten. In this regard, the pet treat 100 may have a thickness 105 small enough such that it can fit between the jaws of a pet, yet large enough to give the sensation similar to that of biting into something substantial such as a piece of meat and/or bone. Accordingly, in an embodiment, the total thickness 105 may be at least 20% of the width 103.

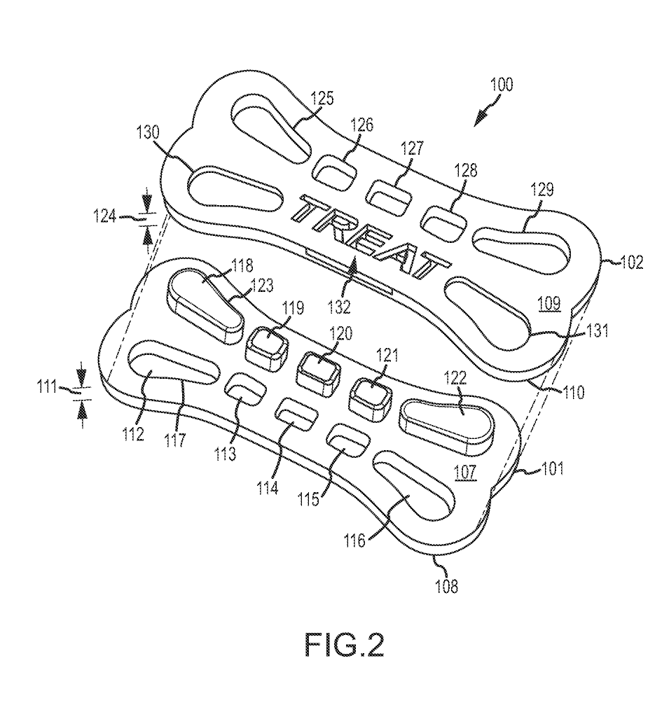

FIG. 2 is an exploded diagram of the pet treat 100 shown in FIG. 1. The first layer 101 may be generally planar and include a first surface 107 and a second surface 108 of the first layer 101. The second surface 108 may be disposed opposite from the first surface 107 and is not visible in FIG. 2. However, since the first and second layers 101, 102 of the illustrated pet treat 100 are similarly sized and shaped, the second surface 108 will appear generally the same as a second surface 109 of the second layer 102 that is visible in FIG. 2. The first surface 107 and the second surface 108 are approximately parallel to each other and their separation distance defines a thickness 111 of the first layer 101.

The first layer 101 may include a plurality of through holes 112-116. As illustrated, one or more of the through holes 112-116 may be irregularly shaped (e.g., not round), and the through holes 112-116 need not all be of the same shape. Moreover, one or more of the through holes 112-116 may have concave portions such as concave portion 117 of through hole 112. In an alternate embodiment, one or more of the holes may not be through holes but may be blind holes extending from the first surface 107 toward the second surface 108. Such blind holes may, for example, extend at least half way through the first layer 101.

The first layer 101 may also include a plurality of protrusions 118-122. As illustrated, one or more of the protrusions 118-122 may be irregularly shaped (e.g., not round), and the protrusions 118-122 need not all be of the same shape. Moreover, one or more of the protrusions 118-122 may have concave portions such as concave portion 123 of protrusion 118. One or more of the protrusions 118-122 may have a height relative to the first surface 107 equal to a thickness 124 of the second layer 102. In this regard, in the pet treat 100 as shown in FIG. 1, the top surfaces of the protrusions 118-122 may be substantially flush with the second surface 109 of the second layer 102. In an alternate embodiment, one or more of the protrusions may have a height relative to the first surface 107 that is less than the thickness 124 of the second layer 102. Such protrusions may, for example, have a height that is at least half of the thickness 124 of the second layer 102.

The second layer 102 may be generally of the same size and shape as the first layer 101. In this regard, the second layer 102 may be generally planar and include a first surface 110 (not visible in FIG. 2) of the second layer 102 and the second surface 109 opposite from the first surface 110. Since the first and second layers 101, 102 of the illustrated pet treat 100 are similarly sized and shaped, the first surface 110 will appear generally the same as the first surface 107 that is visible in FIG. 2. The first surface 110 and the second surface 109 are approximately parallel to each other and their separation distance defines the thickness 124 of the second layer 102.

The second layer 102 may include a plurality of through holes 125-129 that are configured similar to the through holes 112-116 of the first layer 101. Just as in the first layer 101, in an alternate embodiment, one or more of the holes may not be through holes but may be blind holes extending from the first surface 110 toward the second surface 109. Such blind holes may, for example, extend at least half way through the second layer 102.

The second layer 102 may also include a plurality of protrusions (not visible in FIG. 2) that are configured like the protrusions 118-122 of the first layer 101. Just as in the first layer 101, in an alternate embodiment, one or more of the protrusions extending from the second layer 102 may have a height relative to the first surface 110 that is less than the thickness 111 of the first layer 101. Such protrusions may, for example, have a height that is at least half of the thickness 111 of the first layer 101.

One or more indentations may be disposed in the area of the second surface 109 of the second layer 102 that is opposite from the protrusions extending from the first surface 110. For example, indentation 130 may be disposed opposite from a protrusion extending from the first surface 110 that is sized and shaped like protrusion 118. Similarly, indentation 131 may be disposed opposite from a protrusion extending from the first surface 110 that is sized and shaped like protrusion 122. Such indentations 130, 131 may serve several functions. First, the indentations 130, 131 may reduce the overall thickness of the second layer 102 in the area of the protrusions such that the difference between the thickness of the second layer 102 in the area of the protrusion and the thickness of the second layer 102 in other areas is reduced. Such lowered differences in thickness may yield improved molding characteristics in embodiments where the second layer 102 is formed by molding (e.g., injection molding). Second, the indentations 130, 131 may mask imperfections due to the varying thickness of the second layer 102 in the area of the protrusions. Third, the indentations 130, 131 may provide for an aesthetically pleasing symmetry.

The pet treat 100 may include additional indentations 132 that may be in the form of letters or symbols, such as the word “TREAT” shown on layer 102 in FIGS. 1 and 2. Such indentations may serve the same functions as the indentations 130, 131 with the additional benefit of conveying information such as, for example, brand name or flavor.

As illustrated in FIG. 1, when the first and second layers 101, 102 are disposed within the pet treat 100, the first surface 107 of the first layer 101 may be in contact with the first surface 110 of the second layer 102. Relatedly, the second surface 108 of the first layer 101 and the second surface 109 of the second layer 102 may be external surfaces of the pet treat 100. Moreover, the protrusions 118-122 of the first layer 101 may be disposed within the through holes 125-129 of the second layer 102. The protrusions 118-122 may fill each of the through holes 125-129. The protrusions 118-122 may completely fill each of the through holes 125-129 such that the side walls of the protrusions are in contact with the side walls of the through holes. Such contact may be achieved by molding the second layer 102 over the first layer 101 as discussed below. Similarly, the protrusions extending from the first surface 110 of the second layer 102 may be disposed within the through holes 112-116 of the first layer 101. Accordingly, each layer 101, 102 may include protrusions which extend into through holes in the other layer and through holes through which protrusions of the other layer extend. Also, the top surfaces of each protrusion 118-120 of the first layer 101 may be substantially coplanar with the second surface 109, and the top surfaces of each protrusion extending from the first surface 110 of the second layer 102 may be substantially coplanar with the second surface 108 of the first layer 101.

Alternatively, the pet treat 100 may include blind holes in place of the illustrated through holes 112-116, 125-129 and protrusions that are shorter than the thickness of the layer in which they protrude and correspond in length to the depth of the blind holes in which they are positioned.

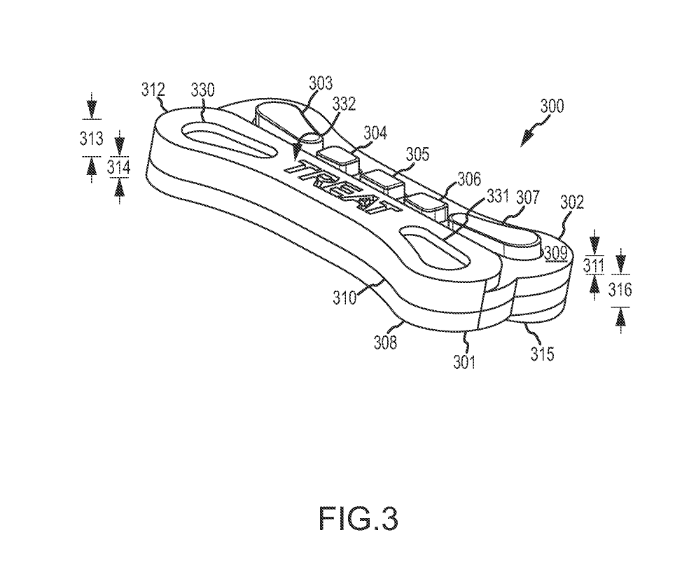

FIG. 3 illustrates an alternative embodiment of a pet treat 300. The pet treat 300 may be similar to the pet treat 100 in that it comprises two interlocking layers: a first layer 301 and a second layer 302. Pet treat 300 also features protrusions 303-307 extending from the first layer 301 and extending beyond a second surface 309 of the second layer 302 (a first surface 310 of the second layer 302 is positioned against the first layer 301 and is not visible in FIG. 3). For example, the protrusions 303-307 may extend a distance from the second surface 309 of the second layer 302 that is greater than one half of a thickness 311 of the second layer 302. As shown in FIG. 3, the protrusions 303-307 may extend a distance from the second surface 309 of the second layer 302 that is about equal to the thickness 311 of the second layer 302.

The second layer 302 of pet treat 300 also features a raised portion 312 where the second layer 302 has a raised portion thickness 313 that is greater than the thickness 311 in the region of the protrusions 303-307. The raised portion 312 may be sized such that it may encompass indentations 330, 331 that are configured similar to indentations 130, 131 of pet treat 100. The raised portion 312 may also encompass indentations 332 that are configured similar to indentations 132 of pet treat 100. Second layer 302 may also include protrusions (not visible in FIG. 3) configured similar to protrusions 303-307 and extending downward from the raised portion 312 through the first layer 301.

The first layer 301 may be configured similar to the second layer 302 in that the first layer 301 may include: a thickness 314 in the portion through which the protrusions of the second layer 302 extend; a raised portion 315 with a raised portion thickness 316 similar to the raised portion 312 and raised portion thickness 313 of the second layer 302; and protrusions (not visible in FIG. 3) similar to protrusions 330, 331 and 332 of the second layer 302.

The second layer 302 may also have protrusions that extend downward (as oriented in FIG. 3) into the first layer 301, similar to as discussed with respect to pet treat 100. Such protrusions may extend into blind holes in the first layer 301; extend into through holes in the first layer 301 such that ends of the protrusions are coplanar with a first surface 308 (facing downward and not visible in FIG. 3) of the first layer 301; or extend through and beyond the first surface 308 in a manner similar to how the protrusions 303-307 extend beyond the second layer 302.

It is noted that, in an embodiment, the protrusions 303-307 may or may not extend beyond the surface 309 and the raised portion 312 may or may not be present. In this regard, these features may be independent and thus may each be independently included or excluded from any particular embodiment. Thus, for example, an embodiment may include protrusions 303-307 extending beyond the surface 309 and not include a raised portion 312. Similarly, any particular layer of an embodiment may or may not include the features. Thus, for example, an embodiment of pet treat may include protrusions 303-307 extending beyond the surface 309 on the second layer 302 and not include the raised portion 312, while the first layer 301 may include the raised portion 315 while not including protrusions extending beyond the first surface 308 of the first layer 301.

Returning to FIGS. 1 and 2 (and also applicable to pet treat 300), as noted, each layer 101, 102 may be of the same size and shape. As illustrated in FIGS. 1 and 2 each layer 101, 102 may be configured such that its through holes are on an opposite side of the central longitudinal axis 106 from its protrusions. In such a configuration, in the final product, the through holes 112-116 of the first layer 101 may be on an opposite side of the central longitudinal axis 106 from the through holes 125-129 of the second layer 102.

Alternatively, the two layers may differ in size and shape. In this regard, the quantity, size, and/or positioning of protrusions and corresponding holes may be different than as illustrated. For example, the through holes and protrusions may be configured such that the two layers are not similarly configured, such as where one layer has more holes than the other layer and the other layer has correspondingly more protrusions than the one layer. In another example, the first layer may include a plurality of holes and no protrusions and the second layer may include a corresponding plurality of protrusions and no through holes. In such a variation, the holes may be blind holes, through holes, or a combination of blind and through holes and the protrusions may be correspondingly configured.

The protrusions of one layer extending into corresponding holes in the other layer provide a mechanical interlock between the two layers. Such interlocking may help to resist delamination between the layers. In this regard, protrusions extending into holes may provide an anchor to help hold the two layers together. Furthermore, multiple protrusions proximate to each other (e.g., protrusions 119 and 120 of FIGS. 1 and 2) may provide for a pinching or spreading effect that may produce increased pressure against sidewalls within the corresponding holes, thereby further anchoring the two layers together. Irregularly-shaped protrusions and corresponding irregularly-shaped holes may provide for increased pressure against sidewalls within the holes. For example, the concave portion 117 of through hole 112 and the correspondingly shaped protrusion of the second layer 102 may interact in such a way to provide for a stronger resistance to delamination than would a round hole and protrusion.

The through holes in one of the layers may have a draft angle such that the through holes are smaller at the first surface than they are at the second surface. For example, the first layer 101 of pet treat 100 may be a molded part and each of the through holes 112-116 may have a draft angle such that the through holes 112-116 are smaller at the first surface 107 than they are at the second surface 108. Thus, if the second layer 102 is overmolded onto the first layer 101, the material of the second layer 102 will flow into the through holes 112-116 and the mating protrusions will be correspondingly larger at the second surface 108 than at the first surface 110. Such a configuration may help to further resist delamination of the layers 101, 102.

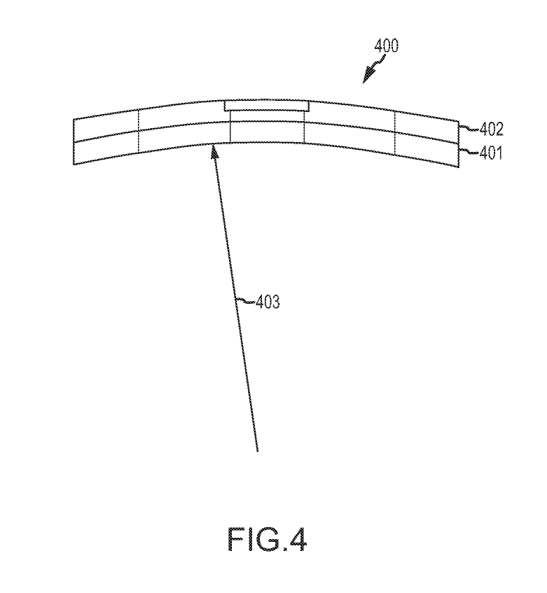

FIG. 4 illustrates another feature that may be incorporated into any of the above-discussed embodiments of a pet treat. FIG. 4 is an edge view of a pet treat 400 with a first layer 401 and a second layer 402 that are configured similar to first layer 101 and second layer 102 with the exception that layers 401, 402 are arched along a central axis about a radius of curvature 403. The radius of curvature 403 may, for example, be between 50 and 200 mm.

The features discussed in relation to FIGS. 3 and 4 may individually or in combination serve to increase the interest of a pet in chewing the pet treat. Moreover, the features may also enhance the delivery of therapy to a pet chewing on the pet treat. For example, the exposed protrusions 303-307 of pet treat 300 may present multiple edges and corners to a pet chewing the pet treat 300 and interaction with such edges and corners may enhance the dental cleaning attribute of the pet treat 300.

The two layers of the pet treats described in the various embodiments herein may be different from each other. For example, the color, taste, hardness, or texture of the first layer may be different than that of the second layer.

One example of such a pet treat is where the first layer is a hard chewy layer and the second layer is a soft layer. The hard chewy layer may be constructed such that it generally will withstand chewing by a pet for a period beyond the initial biting of the pet treat by the pet. For example, the hard chewy layer may remain generally intact for one or more minutes while the pet chews the pet treat. The hard chewy layer may also be constructed to provide for dental cleaning of the pet while the pet is chewing the pet treat.

In various embodiments, the hard chewy layer may have a hardness of at least 40 Shore D, 45 Shore D, 50 Shore D, 55 Shore D, 65 Shore D, or even 70 Shore D or higher. In various embodiments, the hard chewy layer may have a moisture content of not less than about 6, 7, 8, 9, 10, or even 11% and not more than about 8, 9, 10, 11, 12, or even 13%. The hard chewy layer may have a water activity of between 0.451 and 0.456. The hard chewy layer may, for example, include a starch component, glycerin, pineapple fiber, gelatin, modified starch, natural chicken liver flavor, palm oil, calcium carbonate, titanium dioxide, fructooligosaccharide, sodium propionate, sugar, bromeliad enzyme, and alpha tocopheryl acetate. In various embodiments, the starch component may be, for example, wheat gluten, mung bean starch, or any other appropriate starch component.

The soft layer may be constructed such that it is generally softer than the hard chewy layer. For example, the soft layer may have a softness comparable to meat. As the pet bites into the pet treat, teeth in contact with the soft layer may sink into the soft layer more than they sink into the hard chewy layer (e.g., until the progress of the bite is stopped by the hard chewy layer). The pet treat may be constructed such that the soft layer remains interconnected to the hard chewy layer during most or all of the eating process. In this regard, to access the soft layer during the eating process, the pet will also be chewing on the hard chewy layer.

In various embodiments, the soft layer may have a hardness of at most 60 Shore D, 55 Shore D, 50 Shore D, 45 Shore D, 40 Shore D, 35 Shore D, or even 30 Shore D or lower. In various embodiments, the hard chewy layer may have a moisture content of not less than about 5, 6, 7, 8, 9, or even 10% and not more than about 9, 10, 11, 12, 13, or even 14%. The soft layer may have a water activity of between 0.410 and 0.420. The soft layer may, for example, include a meat component, modified starch, glutinous rice flour, glycerin, gelatin, palm oil, and food color. In various embodiments, the meat component may be, for example, dried chicken or dried beef.

The interaction with the soft layer may result in a strong taste sensation for the pet. In this regard, the soft layer may also be more flavorful than the hard chewy layer and thus provide a pleasurable taste sensation to the pet while the pet is biting the pet treat. Such a pleasurable taste sensation may increase the pet's chewing aggression resulting in the dental therapy (and/or any other therapy) delivered by the hard chewy layer being more effective. Notably, since both the hard chewy layer and the soft layer are exposed to the outside of the pet treat, each time the pet bites down on the pet treat, the pet will have the sensation of contacting both the hard chewy layer and the soft layer. This may be different than the sensation the pet may receive if the soft layer were buried between two hard chewy layers or if the soft layer were disposed within a hard chewy layer formed into a cylinder.

The pet treat may be used for other therapeutic purposes aside form or in addition to the delivery of dental therapy. For example, the pet treat may be used to deliver selected nutritional or pharmaceutical elements. Such elements may be mixed into the hard chewy layer, the soft layer, or both. Such elements may be inserted into the pet treat during manufacture.

The hard chewy layer may, for example, comprise a plant protein (e.g., soybean, rice and/or wheat protein), starch, and/or gelatin. The material used to make the hard chewy layer may be configured such that it may be injection molded. In this regard, the material used to make the hard chewy layer may be heated inside a screw that at least partially liquefies the material and forces it into a hard chewy layer mold corresponding to the desired final shape of the hard chewy layer. After the material has been injected, the hard chewy layer mold may be cooled (e.g., by running chilled water through the mold) to cool and solidify the hard chewy layer. The hard chewy layer may then be ejected from the hard chewy layer mold.

The soft layer may, for example, comprise a meat-based material (e.g., in the form of a cooked paste) configured such that it may be injection molded. The process of molding the soft layer may also include heating the material used to make the soft layer within a screw. The heated material used to make the soft layer may be at least partially liquefied within the screw and then forced into a soft layer mold containing a hard chewy layer placed therein, with the mold cavity of the soft layer mold corresponding to the desired final shape of the pet treat. During the molding of the soft layer, the material used to make the soft layer may flow into the through holes and around the protrusions of the hard chewy layer thus interlocking the soft layer to the hard chewy layer. After the material used to make the soft layer has been injected, the pet treat layer mold may be cooled (e.g., by running chilled water through the mold) to cool and solidify the pet treat. The pet treat may then be ejected from the soft layer mold. Optionally, after being ejected, molding imperfections on the pet treat (e.g., flash) may be removed.

At an appropriate time during the process, a barrier layer disposed between the hard and soft layers may be applied. The barrier layer may serve to limit moisture transfer between the hard and soft layers. Without such a moisture barrier, moisture may migrate from the soft layer to the hard chewy layer, causing the textures to tend towards equalization. After the hard chewy layer is placed into the soft layer mold, it may be sprayed with a barrier material such as chitin or chitosan. In this regard, after molding, the barrier layer will be situated between the hard and soft layers. In another example, the hard chewy layer may be completely coated with that barrier layer prior to insertion into the soft layer mold. This variation may be beneficial where the end pet treat is to be bulk packaged and the hard chewy layers of the various bulk packaged pet treats may come into contact with the soft layers of adjacent pet treats.

The described molding process may produce a two-layer pet treat where the layers are mechanically interlocked. The use of protrusions and corresponding holes in each layer may yield a final pet treat with two layers where there is a reduced or eliminated need for a binder material between the layers to secure them to each other. Moreover, because of the heating used during the molding process, additional pasteurization, radiation, or other food safety-related treatments of the pet treat may be unnecessary.

In a variation of the above-described molding process, both layers may be injected into the mold at or nearly at the same time using a double shot process. In another variation, the soft layer may be the first layer molded and the hard chewy layer may be molded over the soft layer.

While various embodiments have been described in detail, it is apparent that further modifications and adaptations of the invention will occur to those skilled in the art. However, it is to be expressly understood that such modifications and adaptations are within the spirit and scope of the present invention.

What is claimed:

1. A pet food product comprising:
a first layer, wherein the first layer includes a first layer first surface and a first layer second surface wherein the first layer first surface and the first layer second surface are approximately parallel to each other and wherein a first layer separation distance between the first layer first surface and the first layer second surface defines a thickness of the first layer, wherein the first layer includes a plurality of first layer holes in the first layer first surface, wherein each hole of the plurality of first layer holes extends at least half way through the thickness of the first layer, wherein the first layer includes a plurality of first layer protrusions extending from the first layer first surface, wherein each protrusion of the plurality of first layer protrusions extends from the first layer first surface a first layer protrusion distance that is at least equal to half the thickness of the first layer; and
a second layer, wherein the second layer includes a second layer first surface and a second layer second surface wherein the second layer first surface and the second layer second surface are approximately parallel to each other and wherein a second layer separation distance between the second layer first surface and the second layer second surface defines a thickness of the second layer, wherein the second layer includes a plurality of second layer holes in the second layer first surface, wherein each hole of the plurality of second layer holes extends at least half way through the thickness of the second layer, wherein the second layer includes a plurality of second layer protrusions extending from the second layer first surface, wherein each protrusion of the plurality of second layer protrusions extends from the second layer first surface a second layer protrusion distance that is at least equal to half the thickness of the second layer,
wherein the plurality of first layer protrusions are disposed within the plurality of second layer holes, wherein the plurality of second layer protrusions are disposed within the plurality of first layer holes, wherein the first layer first surface is in contact with the second layer first surface, wherein the pet food product further comprises a length and a width, wherein the first layer second surface and the second layer second surface are external surfaces of the pet food product.

2. The pet food product of claim 1, wherein the first layer is harder than the second layer.

3. The pet food product of claim 2, wherein the first layer is a hard chewy layer and the second layer is a soft meaty layer.

4. The pet food product of claim 2, wherein the plurality of first layer holes are through holes, wherein the plurality of second layer holes are through holes.

5. The pet food product of claim 4, wherein the plurality of first layer protrusions extends from the first layer first surface to the second layer second surface, wherein the plurality of second layer protrusions extends from the second layer first surface to the first layer second surface.

6. The pet food product of claim 5, wherein the plurality of first layer protrusions extends from the first layer first surface to beyond the second layer second surface.

7. The pet food product of claim 6, wherein the plurality of second layer protrusions extends from the second layer first surface to beyond the first layer second surface.

8. The pet food product of claim 5, wherein the length is at least as large as the width, wherein the total thickness is at least 20% of the width.

9. The pet food product of claim 5, wherein the thickness of the first layer is equal to the thickness of the second layer.

10. The pet food product of claim 5, wherein the first and second layers are of substantially the same size and shape.

11. The pet food product of claim 5, further comprising a central longitudinal axis disposed along the length of the pet food product, wherein the plurality of first layer holes are disposed on an opposite side of the central longitudinal axis from the plurality of second layer holes.

12. The pet food product of claim 5, wherein the length is between 50 and 200 mm, wherein the width is between 20 and 80 mm, wherein the total thickness is between 6 and 24 mm.

13. The pet food product of claim 5, wherein the first layer has a hardness of at least 50 Shore D, wherein the second layer has a hardness of at most 45 Shore D.

14. The pet food product of claim 5, wherein the first layer has a moisture content of between 9 and 10 percent, wherein the second layer has a moisture content of between 8 and 11 percent.

15. The pet food product of claim 5, wherein the first layer has a water activity of between 0.451 and 0.456, wherein the second layer has a water activity of between 0.410 and 0.420.

16. The pet food product of claim 5, wherein the first layer comprises a starch component, glycerin, pineapple fiber, gelatin, modified starch, natural chicken liver flavor, palm oil, calcium carbonate, titanium dioxide, fructooligosaccharide, sodium propionate, sugar, bromeliad enzyme, and alpha tocopheryl acetate.

17. The pet food product of claim 16, wherein the starch component comprises at least one of wheat gluten or mung bean starch.

18. The pet food product of claim 5, wherein the second layer comprises a meat component, modified starch, glutinous rice flour, glycerin, gelatin, palm oil, and food color.

19. The pet food product of claim 18, wherein the meat component comprises at least one of dried chicken or dried beef.

20. The pet food product of claim 5, wherein the first layer is generally planar, and wherein the second layer is generally planar.

21. The pet food product of claim 5, wherein the first layer is arched, and wherein the second layer is arched.

22. A pet food product comprising:
a first layer,
wherein the first layer includes a first layer first surface and a first layer second surface wherein the first layer first surface and the first layer second surface are approximately parallel to each other and wherein a first layer separation distance between the first layer first surface and the first layer second surface defines a thickness of the first layer,
wherein the first layer includes a plurality of holes in the first layer first surface,
wherein each hole of the plurality of holes extends at least half way through the thickness of the first layer; and
a second layer,
wherein the second layer includes a second layer first surface and a second layer second surface wherein the second layer first surface and the second layer second surface are approximately parallel to each other and wherein a second layer separation distance between the second layer first surface and the second layer second surface defines a thickness of the second layer,
wherein the second layer includes a plurality of protrusions extending from the second layer first surface,
wherein each protrusion of the plurality of second layer protrusions extends from the second layer first surface a second layer protrusion distance that is at least equal to half the thickness of the second layer,
wherein the plurality of protrusions are disposed within the plurality of holes,
wherein the first layer first surface is in contact with the second layer first surface,
wherein the first layer second surface and the second layer second surface are external surfaces of the pet food product.

23. The pet food product of claim 22, wherein the plurality of holes are through holes.

24. The pet food product of claim 21, wherein the plurality of protrusions extend from the second layer first surface to the first layer second surface.

25. The pet food product of claim 24, wherein the plurality of protrusions extend from the second layer first surface to beyond the first layer second surface.

26. The pet food product of claim 24, wherein the first layer is generally planar, and wherein the second layer is generally planar.

27. The pet food product of claim 24, wherein the first layer is arched, and wherein the second layer is arched.

28. A method of making a pet food product, the method comprising:
forming a first layer in a first mold, wherein the first layer is made of a first formulation;
removing the first layer from the first mold;
inserting the first layer into a second mold;
injection molding a second layer onto the first layer in the second mold, wherein the injection molding comprises injecting a second formulation into the second mold, pushing the second formulation into holes located in the first layer, and surrounding protrusions of the first layer with the second formulation; and
removing the pet food product from the second mold.

29. The method of claim 28, wherein the forming step includes injection molding.

30. The method of claim 29, wherein the forming step includes heating the first formulation.

31. The method of claim 30, wherein the forming step includes chilling the first formulation while the first formulation is in the first mold.

32. The method of claim 31, wherein the injection molding the second layer step includes heating the second formulation.

33. The method of claim 32, wherein the injection molding the second layer step includes chilling the second formulation while the second formulation is in the second mold.

34. The method of claim 33, further comprising applying a moisture barrier to the first layer after the forming step and prior to the injection molding the second layer step.
